(19) United States
(12) Patent Application Publication
(10) Pub. No.: US 2002/0010632 A1
(43) Pub. Date: Jan. 24, 2002

(54) Method and apparatus for receiving an order for goods and drive-through system with the apparatus

(76) Inventors: Kesayoshi Iguchi, Fujisawa-shi (JP); Hiroyuki Tanaka, Yokohama (JP)

Correspondence Address: PARKHURST & WENDEL, L.L.P., 1421 Prine Street, Suite 210, Alexandria, VA, 22314-2805, US

(21) Appl. No.: 09/783,978

(22) Filed: Feb. 16, 2001

(30) Foreign Application Priority Data
Feb. 18, 2000 (JP) 2000-41025

(51) Int. Cl. G06F 17/60

(52) U.S. Cl. 705/16

(57) ABSTRACT

This invention is intended to instruct a kitchen of orders taken at random in sequence of customers, and to rearrange the orders in order to cook in sequence of the customers. A piece of commodity name information 21, a piece of unit price information 22, and a piece of position number information 23 are set into a commodity-setting table in an electronic cash register. When the order is taken in advance, a desired quantity of a corresponding commodity on an order form is marked, and then the order form is read by means of a mark reader that is connected to the register. As an alternative, when the order is taken in advance, an either slip or receipt containing an either customer number or receipt number is handed to each customer so that the customer number or receipt number may be entered into the register at an order window. As a further alternative, order contents and an identification number are transmitted using a portable terminal to a controller disposed in an establishment, while the identification number is handed to each customer so that the identification number may be read at the order window, thereby causing the controller to perform collating.

### BACKGROUND OF THE INVENTION

1. Field of the Invention

This invention relates to a commodity order-taking method and apparatus and a drive-through system either employing the commodity order-taking method or provided with the commodity order-taking apparatus. More particularly, it relates to a commodity order-taking method and apparatus and a drive-through system either employing the commodity order-taking method or provided with the commodity order-taking apparatus, which are applicable to a drive- or walk-through system employed in fast-food restaurants.

2. Description of the Related Art

As illustrated in FIG. 28, a prior art drive-through system used such as in fast-food restaurants includes an order-taking register 284 for registering an order passed by a customer seated in an automobile 282 that arrives at an order booth in an establishment, a controller 286 disposed in a kitchen for receiving order contents from the order-taking register 284, a display monitor 287 connected to the controller 286 for displaying the order contents, a casher register 285 for calling the order contents from the controller 286 for payment, a front counter register 288 for registering orders from customers present in the establishment, and a communication cable 289 connecting the registers with the controller 286.

While the customer in the automobile 282 passes the order at the order booth, a subsequent customer in automobiles 281 waits in a queue, and then advances to a position at which the automobile 282 stops when the order booth is vacated. After completing ordering commodities, the customer in the automobile 282 moves to a casher booth, at which the customer receives the commodities and makes payment. The order-taking register 284 registers the order that is received from the automobile 282 at the order booth, and the registered order is sent to the controller 286 via the cable 289. As illustrated in FIG. 29, the display monitor 287 displays details of the order. Watching the monitor 287, a cook prepares the commodities ordered, and then carries the prepared commodities to the casher booth. The automobile 282 having already placed the order moves to the casher booth from the order booth. The casher register 285 reads out the orders from the controller 286 in sequence of order receipt, and then the customer in the automobile 283 at the casher booth makes payment. After the payment, the casher register 285 notifies the controller 286 that all steps are completed, and then the order contents are erased from the controller 286.

In a walk-through system, people move instead of the automobiles, but sales are made in a manner similar to those as practiced in the drive-through system.

However, problems with the conventional drive- and walk-through systems are that the customers ponder on selection of orders at the order booth because placing the orders at the order booth, thereby increasing order-taking time and thus decreasing sales per unit hour, and further that, when employees badly attend to the customers, then the customers may leave the establishment without placing any orders, with a consequential reduction in sales in the establishment. In order to obviate the problems, when the drive-through establishment becomes jammed with the automobiles, then an employee accesses the automobiles in order to take orders promptly in advance. The employee takes successive orders in a face-to-face manner from the customers in the queuing automobiles 281, and thereby fills in commodities ordered into each order form as shown in FIG. 30. The employee brings the order forms to the order-take register 284, and then another employee who operates the register 284 registers the commodities ordered. In this way, the orders are processed faster. However, this system suffers from another problem in which order taking practiced by a plurality of employees as well as the automobiles waiting in a plurality of queues may cause mismatches between the sequence of registration executed according to the order forms and the sequence of the automobiles.

### SUMMARY OF THE INVENTION

In order to overcome the drawbacks encountered in the prior art, an object of the present invention is to provide a commodity order-taking method and apparatus designed to automatically identify customers with orders in sequence when the customers come to an order booth, which orders are taken in advance.

A commodity order-taking method according to one aspect of the present invention comprises the steps of: taking an order for a commodity from each customer in advance, recoding the order on a slip, and then handing the slip to the customer before the order is accepted at an order window; passing the slip from the customer to the order window when the customer comes to the order window; reading the slip using a reader at the order window; and entering it into a register, thereby identifying the customer at the order window with order contents. Consequently, the customers can automatically be identified with the orders in sequence, even when the orders are taken from the customers in advance. As a result, order-taking time can be reduced, which can highly satisfy the customers.

A commodity order-taking apparatus according to one aspect of the present invention comprises: a reading means for reading the content of a slip having a commodity name and its quantity recorded thereon at specific locations; and a commodity-registering means connected to the reading means for registering a commodity ordered, its quantity, and a selling price according to the read contents of the slip, the commodity-registering means including a set price-storing means for storing a position and unit price of each commodity name presented on the slip and a calculating means for checking position data read from the slip by the reading means against position data stored in the set price-storing means according to the slip, thereby determining the commodity and then calculating the selling price on the basis of the quantity of the determined commodity. As a result, mismatches in sequence between orders and customers can be prevented, even when the orders taken in advance at a position other than the order booth are processed at the order booth. In addition, the mechanical steps allow order taking to be practiced more quickly, and thoroughly satisfy the customers. Furthermore, taking the orders in advance makes it possible to reduce processing time at the order booth.

A commodity order-taking method according to another aspect of the present invention comprises the steps of: taking an order for a commodity from each customer in advance, recoding the order and a customer number on a slip, and registering the order and the customer number into a register before the order is accepted at an order window; and entering the customer number into the register when the customer comes to the order window, thereby identifying the customer at the order window with order contents. Consequently, the customers can automatically be identified with the orders in sequence, even when the orders are taken from the customers in advance. As a result, order-taking time can be reduced, which can highly satisfy the customers.

A commodity order-taking apparatus according to a further aspect of the present invention comprises: an input means for entering the contents of a slip having a commodity name, its quantity, and a customer number recorded thereon; a storage means for storing the entered commodity name, quantity, and customer number; and a calculating means for entering the customer number via the input means in order to read from the storage means the commodity name and quantity identified by the customer number, thereby calculating a selling price on the basis of the quantity. Consequently, registering an order is completed before each customer comes to the order booth, and then the corresponding order is called according to a vehicle number when the customer comes to the order booth, thereby making it possible to identify the order with the customer. As a result, the orders can be registered at random. Furthermore, the customers can smoothly be identified with the orders in sequence according to the customer numbers without mechanical steps, even if the customers are changed in sequence.

A commodity order-taking method according to a yet further aspect of the present invention comprise the steps of: taking an order for a commodity from each customer in advance and then registering the order into a register, and then handing to the customer a receipt containing a receipt number, before the order is accepted at an order window; receiving the receipt from the customer when the customer comes to the order window; and entering the receipt number into the register, thereby identifying the customer at the order window with order contents. Consequently, the customers can automatically be identified with the orders in sequence, even when the orders are taken from the customers in advance. As a result, order-taking time can be reduced, and the customers are very much satisfied.

A commodity order-taking apparatus according to a yet further aspect of the invention comprises: an input means for entering a commodity name and its quantity; a receipt-issuing means for issuing a receipt containing the entered commodity name and quantity as well as a receipt number; a storage means for storing the entered commodity name and quantity as well as the receipt number; and a calculating means for entering the receipt number via the input means in order to read from the storage means the commodity name and quantity identified by the receipt number, thereby calculating a selling price from the quantity. Consequently, registering an order is completed before each customer comes to the order booth, and then the corresponding order is called according to the receipt number when the customer comes to the order booth, thereby making it possible to identify the order with the customer. As a result, the orders can be registered at random. In addition, the customers and the orders can smoothly be identified with one another in sequence according to the receipt numbers without mechanical steps, even if the customers are changed in sequence.

A commodity order-taking method according to still another aspect of the present invention comprises the steps of: taking an order for a commodity from each customer in advance, transmitting the order to a controller by wireless, and then handing to the customer a tag capable of sending out an identification number, before the order is accepted at an order window; receiving the identification number from the tag when the customer comes to the order window; and transmitting the identification number to the controller, thereby identifying the customer at the order window with order contents. Consequently, the customers can automatically be identified with the orders in sequence, even when the orders are taken from the customers in advance. As a result, order-taking time can be reduced, which can highly satisfy the customers.

A commodity order-taking apparatus according to yet another aspect of the present invention comprises: a tag capable of transmitting an identification number; a portable terminal means for entering and then transmitting commodity data by wireless, the commodity data including a commodity name, its quantity, and a selling price as well as the identification number; a receiving means for receiving the commodity data from the portable terminal means; a responding means for receiving the identification number from the tag; and a control means for retrieving specific commodity data from among the commodity data received by the receiving means, the specific commodity data being identified by the identification number entered from the responding means. Consequently, while the tag is handed to each customer, registering an order is completed before the customer comes to the order booth, and then the corresponding order is called according to the tag number when the customer comes to the order booth, thereby making it possible to identify the order with the customer. As a result, the orders can be registered at random. In addition, no employee is required at the order booth, and the establishment can be run at reduced costs.

A commodity order-taking method according to a still further aspect of the present invention comprises the steps of: taking an order for a commodity from each customer in advance, transmitting the order to a controller by wireless, and then handing the customer a receipt showing a receipt number, before the order is accepted at an order window; reading the receipt number using a barcode reader when the customer comes to the order window; and sending the receipt number to the controller, thereby identifying the customer at the order window with order contents. Consequently, the customers can automatically be identified with the orders in sequence, even when the orders are taken from the customers in advance. As a result, order-taking time can be reduced, which can highly satisfy the customers.

A commodity order-taking apparatus according to a still further aspect of the present invention comprises: a portable terminal means for entering and then transmitting commodity data by wireless, the commodity data including a commodity name, its quantity, and a selling price as well as a receipt number, the portable terminal means further for issuing a receipt having the receipt number printed thereon in a barcode; a receiving means for receiving the commodity data from the portable terminal means; a reading means for reading the receipt number in the barcode from the receipt; and a control means for retrieving specific commodity data from among the commodity data received by the receiving means, the specific commodity data being identified by the receipt number entered from the reading means. Consequently, while the receipt is handed to each customer, registering an order is completed before the customer comes to the order booth, and then the corresponding order is called according to the receipt number when the customer comes to the order booth, thereby making it possible to identify the order with the customer. As a result, the orders can be registered at random.

The present invention provides a drive-through system equipped with the commodity order-taking apparatus as defined in any one of the above aspects of the invention, designed to automatically identify the customers with the orders in sequence, even when the orders are taken from the customers in advance. As a result, order-taking time can be reduced, and the customers are very much satisfied.

### BRIEF DESCRIPTION OF THE DRAWINGS

These and other objects and features will become apparent by reference to the following detailed description of the preferred embodiment of the present invention, taken in connection with the accompanying drawings, in which:

FIG. 1 is a format chart, illustrating an order form according to a first embodiment of the present invention;

FIG. 2 is a table, illustrating a commodity-setting table according to the first embodiment;

FIG. 3 is a block diagram, illustrating a structure of an order-taking register according to the first embodiment;

FIG. 4 is a perspective view, showing the order-taking register and a reader according to the first embodiment;

FIG. 5 is a front view, showing a keyboard according to the first embodiment;

FIG. 6 is a flowchart, illustrating key operation steps according to the first embodiment;

FIG. 7 is a flowchart, illustrating key-processing steps in the order-taking register according to the first embodiment;

FIG. 8 is a format chart, illustrating an order form according to a second embodiment;

FIG. 9 is a block diagram, showing a structure of an order-taking register according to the second embodiment;

FIG. 10 is a front view, showing a keyboard according to the second embodiment;

FIG. 11 is a simulative illustration, showing the stored contents of a user memory according to the second embodiment;

FIG. 12 is a flowchart, showing key operation steps during registration according to the second embodiment;

FIG. 13 is a flowchart, showing key operation steps during transmittance according to the second embodiment;

FIG. 14 is a flowchart, illustrating key-processing steps in the order-taking register according to the second embodiment;

FIG. 15 is a format chart, showing a receipt according to a third embodiment;

FIG. 16 is a block diagram, showing a structure of an order-taking register according to a third embodiment;

FIG. 17 is a simulative illustration, showing the stored contents of a journal memory according to the third embodiment;

FIG. 18 is a flowchart, showing key operation steps during transmittance according to the third embodiment;

FIG. 19 is a flowchart, illustrating key-processing steps in the order-taking register according to the third embodiment;

FIG. 20 is a simulative illustration, showing a structure of a drive-through system according to a fourth embodiment;

FIG. 21 is a front view, illustrating a keyboard according to the fourth embodiment;

FIG. 22 is a flowchart, illustrating key operation steps during registration according to the fourth embodiment;

FIG. 23 is a simulative illustration, showing the stored contents of an order memory in a controller according to the fourth embodiment;

FIG. 24 is a flowchart, illustrating processing steps in the controller according to the fourth embodiment;

FIG. 25 is a simulative illustration, showing a structure of a drive-through system according to a fifth embodiment;

FIG. 26 is a format chart, showing a receipt according to the fifth embodiment

FIG. 27 is a flowchart, illustrating processing steps in a controller according to the fifth embodiment;

FIG. 28 is a simulative illustration, showing a structure of a conventional drive-through system;

FIG. 29 is a simulative illustration, showing a screen display on a display monitor in the conventional drive-through system; and

FIG. 30 is a format chart, showing an order form in the conventional drive-through system.

### DESCRIPTION OF THE PREFERRED EMBODIMENTS

Preferred embodiments of the present invention will now be described with reference to the drawings. Although the following description exemplifies a drive-through system, the present invention is applicable to a walk-through system as well.

(First Embodiment)

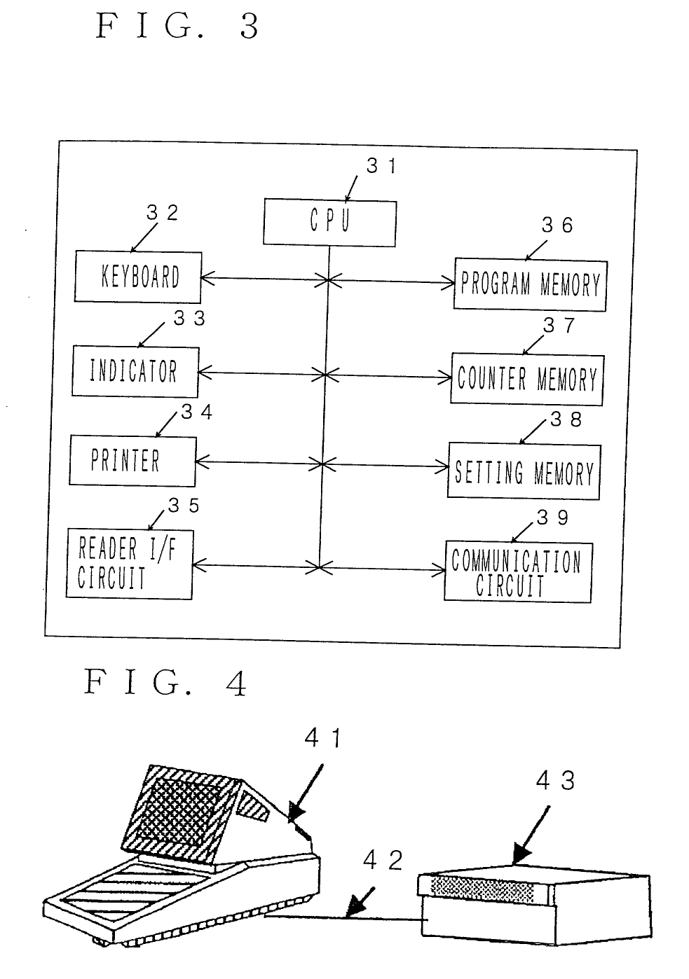

As illustrated in FIG. 4, a commodity order-taking apparatus according to a first embodiment includes an order-taking register 41 and a mark reader 43, which are connected together through a communication cable 42. Alternatively, the order-taking register 41 having the mark reader 43 built therein may be used. As illustrated in FIG. 3, the order-taking register 41 includes a CPU 31 for providing calculation and input-output control according to a program, a keyboard 32 for registering commodities and entering an amount of money, an indicator 33 for indicating registered contents, a printer 34 for printing a receipt, an interface circuit 35 connected to the mark reader 43, a program memory 36 containing an operating program, a counter memory 37 for storing a selling price and quantities of the commodities, a setting memory 38 for storing commodity names, unit prices, and respective positions of the commodities shown on an order form, and a communication circuit 39 for communicating with a controller and a casher register.

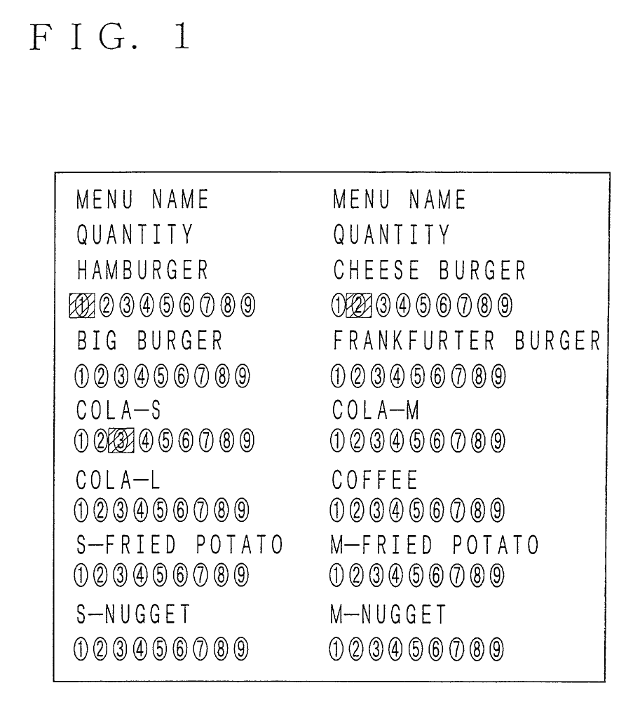

FIG. 1 illustrates an example of the order form, on which menu names and quantities to be sold are printed in advance at predetermined positions. In the illustrated example, respective six sets (a total of twelve sets) of commodities, each of which has a series of numerals 1-9 printed under each commodity name (menu name) for showing a quantity of the commodity, are printed out on the order form along leftward and rightward columns of the order form. In the order form, position numbers such as 1, 2, 3, 4, . . . 11, 12 allocated to each commodity name from the left to the right of each of the columns are arranged in sequence in a downward direction of the order form. The order form is handed to a customer in each automobile queuing from an order booth in order to paint over desired numerals on the order form, or otherwise an employee attends to the customers for the same purpose. In this way, orders are taken in advance from the customers. For example, when an order for one hamburger is passed, numeral “1” under the character “hamburger” is painted over. In this way, order taking is practiced, and thereafter the order form is handed to the customer, who is at this time instructed to pass the order form to another employee at the order booth when the customer comes to the order booth.

The employee in receipt of the order form inserts the order form into the mark reader 43, and then sends instructions from the order-taking register 41 to the mark reader 43 to read the order form. The mark reader 43 reads and scans the order form as shown FIG. 1 from above the order form in order to detect respective positions of the painted numerals. The mark reader 43 is thereby allowed to output respective pieces of position information and quantity information for the commodity names.

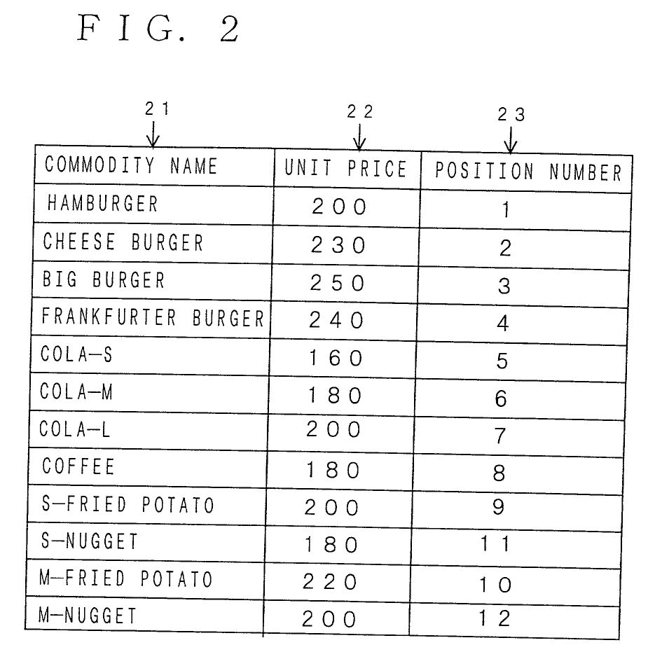

FIG. 2 illustrates a commodity-setting table including commodity names, unit prices, and menu position numbers, which are all set into the setting memory 38. The commodity-setting table sets a piece of commodity name information 21, which appears on both a screen of the indicator 33 and a receipt, a piece of commodity unit price information 22, and a piece of information 23 on position numbers of commodities on the order form.

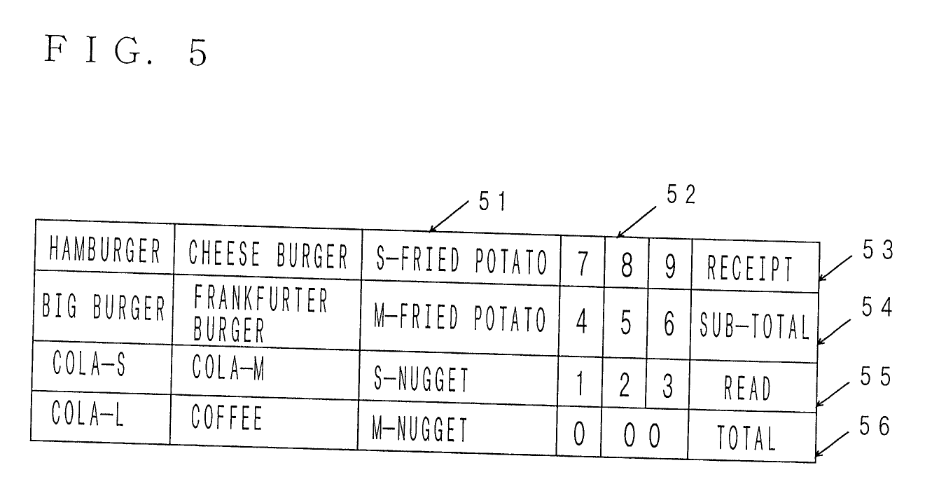

FIG. 5 illustrates a structure of the keyboard 32, which includes commodity keys 51 for entering kinds of commodities to be sold, numeral keys 52 for entering numerals, a receipt key 53 for issuing instructions to print a receipt, a subtotal key 54 for determining a subtotal amount of money, a read key 55 for reading the contents of the order form from the mark reader 43, and a sum key 56 for calculating a total amount of money and then sending the order to the controller.

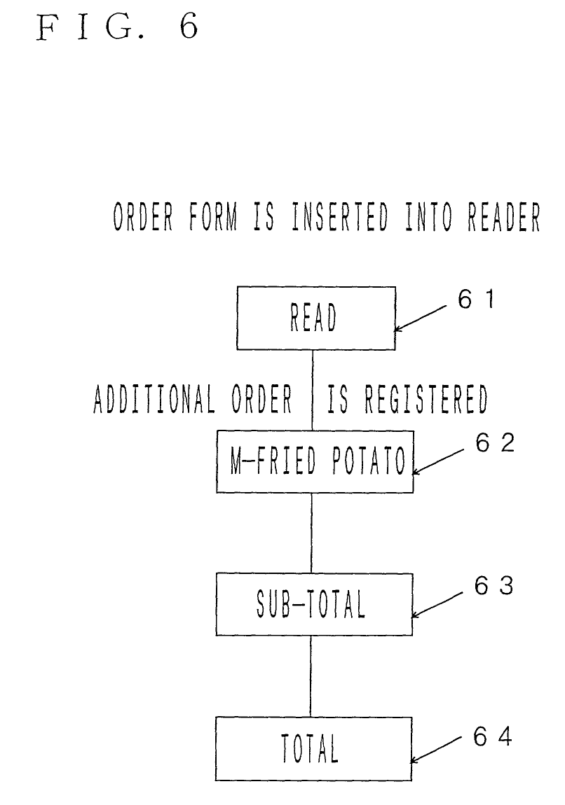

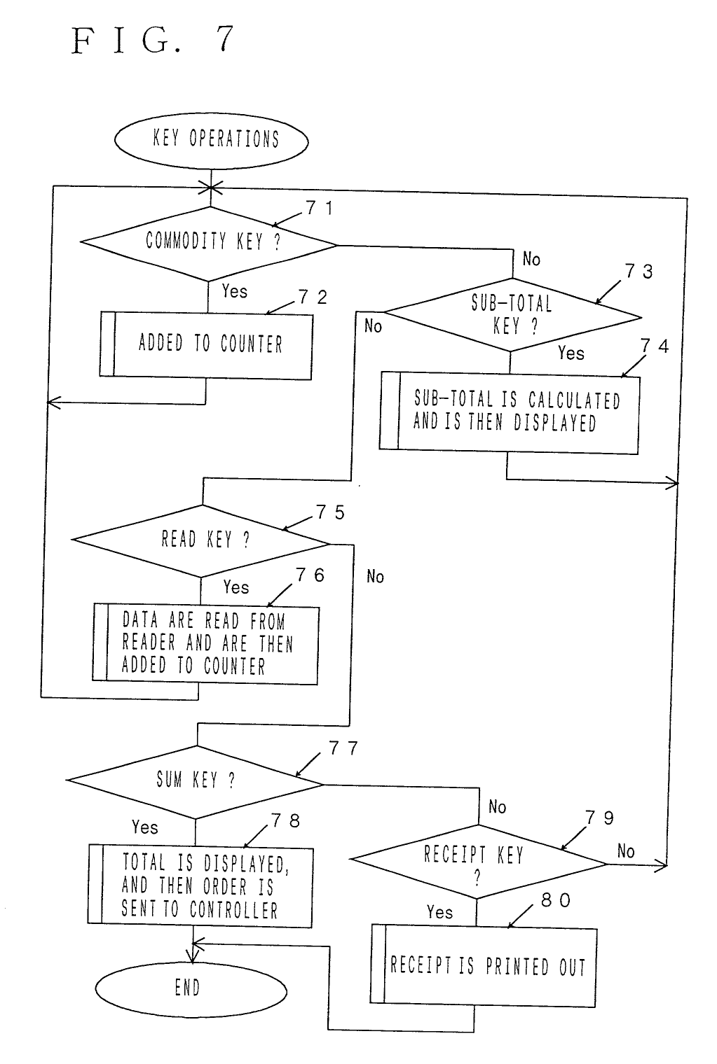

FIG. 6 illustrates an example of keyboard operations by an employee who operates the order-taking register. At initial step 61, the order form is inserted into the mark reader 43 upon receipt of the order form from the customer, and then the read key 55 is pressed to read order contents. When an additional order is passed, then “M-fried potato”, e.g., is additionally registered by means of the commodity key 51 at step 62. When the customer completes giving the order, then the subtotal key 54 is pressed to notify the customer of a subtotal amount of money at step 63. At step 64, the sum key 56 is pressed to fix the order, and then the order contents are sent to the controller in the kitchen from the communication circuit 39 via the communication cable. Subsequent steps are taken in a manner similar to those practiced in the prior art. More specifically, watching details of the order displayed on the display monitor in the kitchen, a cook in the kitchen prepares the commodities ordered, and then carries the prepared commodities to the casher booth, while the automobile having already placed the order is advanced from the order booth to the casher booth; the casher register reads out the orders from the controller in sequence of order receipt, and then the customer in the automobile at the casher booth makes payment; and the casher register thereafter notifies the controller that all steps are completed, and then the order contents are erased from the controller.

FIG. 7 illustrates a schematic routine for key operations at the CPU 31 during the above steps. At initial step 71, it is determined whether the commodity key 51 is pressed, and when the determination in step 71 results in a positive answer, the routine is advance to step 72, or otherwise is shifted to step 73. At step 72, a unit price of a corresponding commodity is called from the commodity-setting table stored in the setting memory 38, and then a selling price and a quantity are added to the counter memory 37 before the routine is returned to step 71. At step 73, it is determined whether the subtotal key 54 is pressed, and when the determination in step 73 results in a positive answer, then the routine is advanced to step 74, or otherwise is moved to step 75. At step 74, a subtotal amount of money is calculated and then displayed on the indicator 33 before the routine is returned to step 71. The above description is concerned with an additional routine. When no commodity is added, processing starts with step 75. At step 75, it is determined whether the read key 55 is pressed, and when the determination in step 75 results in a positive answer, then the routine is advanced to step 76, or otherwise is shifted to step 77. At step 76, the mark reader 43 reads a position and quantity of each commodity on the order form; a unit price is read from a table in which commodity position information identifies with the commodity position number 23 in the setting memory 38; a selling price is calculated; and the selling price and quantity are added to the counter memory 37, and then the routine is returned to step 71. When no commodity is added, the routine is shifted to the step 77. At step 77, it is determined that sum key 56 is pressed, and when the determination in step 77 results in a positive answer, then the routine is advanced to step 78, or otherwise is shifted to step 79. At step 78, a total amount of money is displayed on the indicator 33, and then the order is sent from the communication circuit 39 to the controller via the communication cable, thereby completing one transaction. At step 79, it is determined whether the receipt key 53 is pressed, and when the determination in the step 79 results in a positive answer, then the routine is advanced to step 80, or otherwise is returned to step 71. At step 80, the printer 34 issues a receipt, and then one transaction is completed.

As described above, the commodity order-taking apparatus according to the first embodiment includes the mark reader 43 for reading the contents of the order form having the commodity names and quantities recorded thereon at specific positions and the order-taking register 41 connected to the mark reader 43 for registering the commodities ordered, quantities thereof, and a selling price according to the read contents of the order form. The order-taking register 41 includes the setting memory 38 for storing the positions and unit prices of the commodity names presented on the order form and the CPU 31 for checking a piece of position information read from the order form by the mark reader 43 against another piece of position information stored in the setting memory 38 according to the order form, thereby determining the commodities and then calculating the selling price on the basis of the quantities of the determined commodities. As a result, mismatches in sequence between orders for commodities and customers can be prevented, even when the orders taken in advance at a position other than the order booth are processed at the order booth. In addition, the mechanical steps allow order taking to be practiced more quickly, and thoroughly satisfy the customers. Furthermore, taking the orders in advance makes it feasible to reduce processing time at the order booth.

Although the order is received using the order form made of a paper medium according to the first embodiment, an either magnetic or IC card may be used as the order form in order to record the order contents by means of a card writer.

(Second Embodiment)

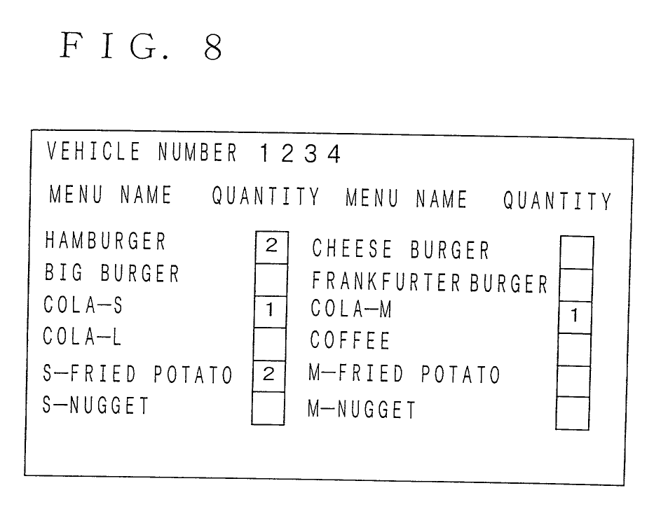

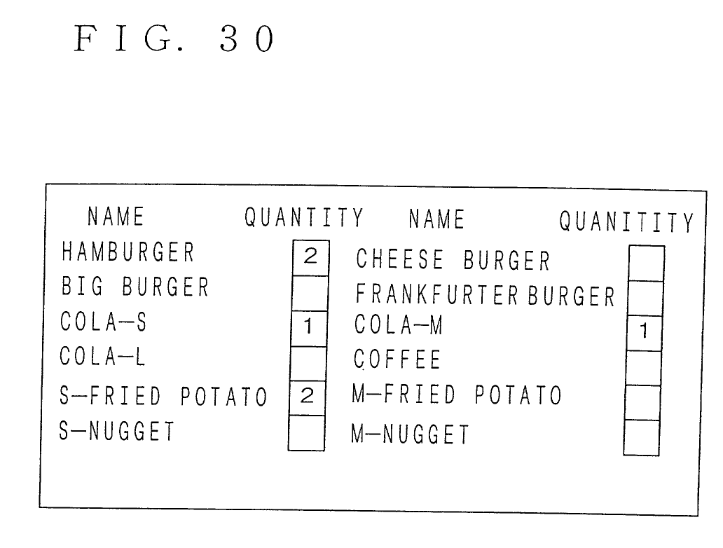

A commodity order-taking apparatus according to a second embodiment includes a user memory disposed in an order-taking register for placing a customer number on an order form and storing order details for each customer number and customer. FIG. 8 illustrates an example of an order form according to the second embodiment. This order form is similar to a conventional order form as illustrated in FIG. 30, but includes a space in which a vehicle number (numerals on a number plate) is written by way of the customer number so that an employee may fill in the vehicle number into the order form, while taking an order from the customer.

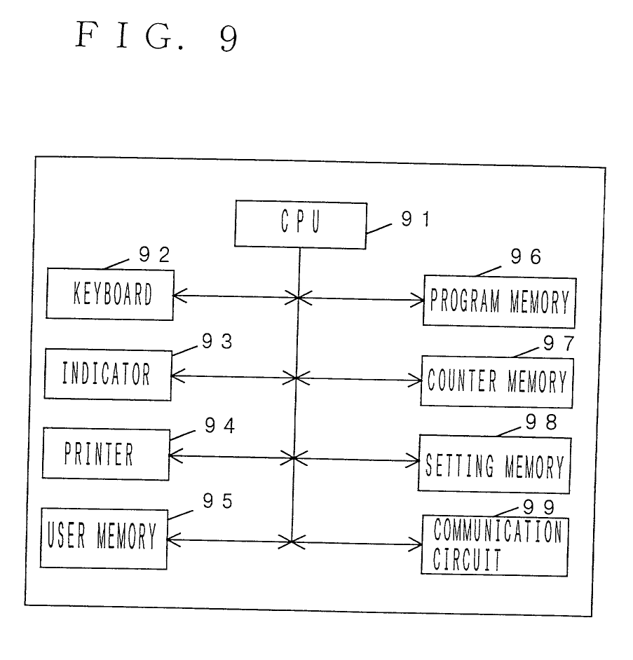

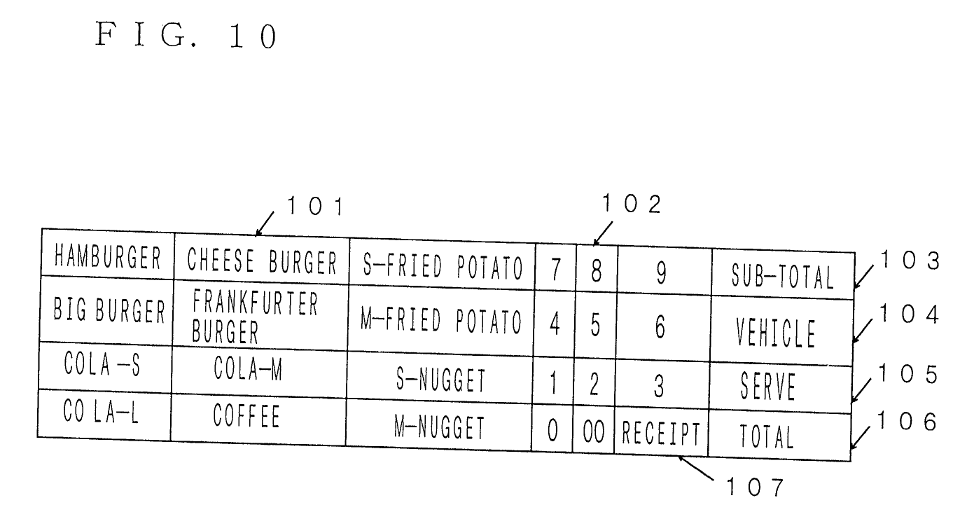

FIG. 9 illustrates an internal construction of the order-taking register according to the second embodiment. The order-taking register includes a CPU 91 for providing calculation and input-output control according to a program, a keyboard 92 for registering commodities and entering an amount of money, an indicator 93 for indicating registered contents, a printer 94 for issuing a receipt, a user memory 95 for storing the vehicle number and the order details, a program memory 96 containing an operating program, a counter memory 97 for storing a selling price and quantities of the commodities, a setting memory 98 for storing commodity names and unit prices, and a communication line 99 for communicating with a controller and a casher register. The above order-taking register differs from the order-taking register as shown in FIG. 3 in that the user memory 95 is added to the latter register, but the reader I/F circuit is deleted therefrom.

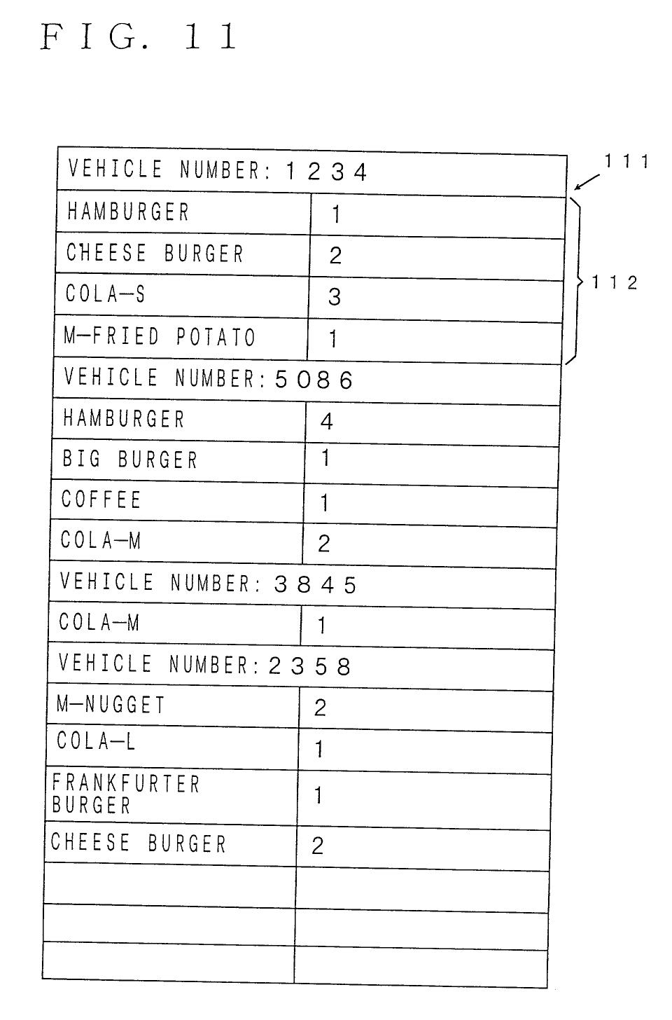

FIG. 10 illustrates an example of the keyboard according to the second embodiment. The keyboard includes commodity keys 101 for entering kinds of commodities to be sold, numeral keys 102 for entering numerals, a subtotal key 103 for determining a subtotal amount of money, a vehicle key 104 for registering the vehicle number, a serve key 105 for provisionally adding up a payment amount, a sum key 106 for calculating a total amount of money and then sending an order to the controller, and a receipt key 107 for issuing instructions to print a receipt.

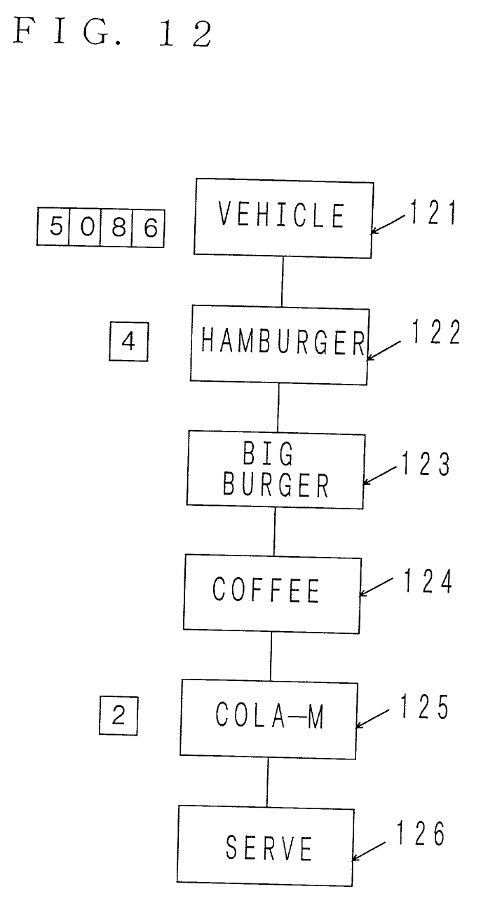

FIG. 11 illustrates what the user memory 95 stores according to the second embodiment, in which a piece of order detail information 112 combined with each piece of vehicle number information 111 is saved.

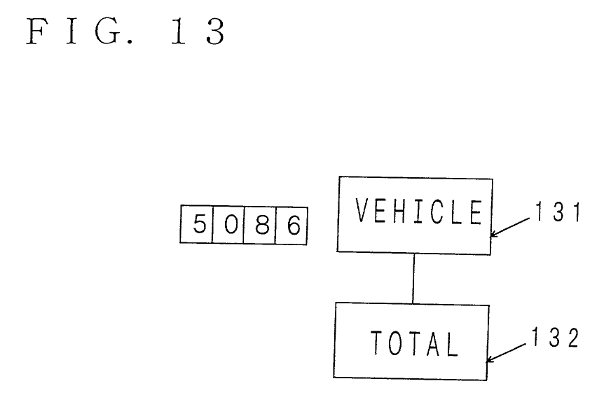

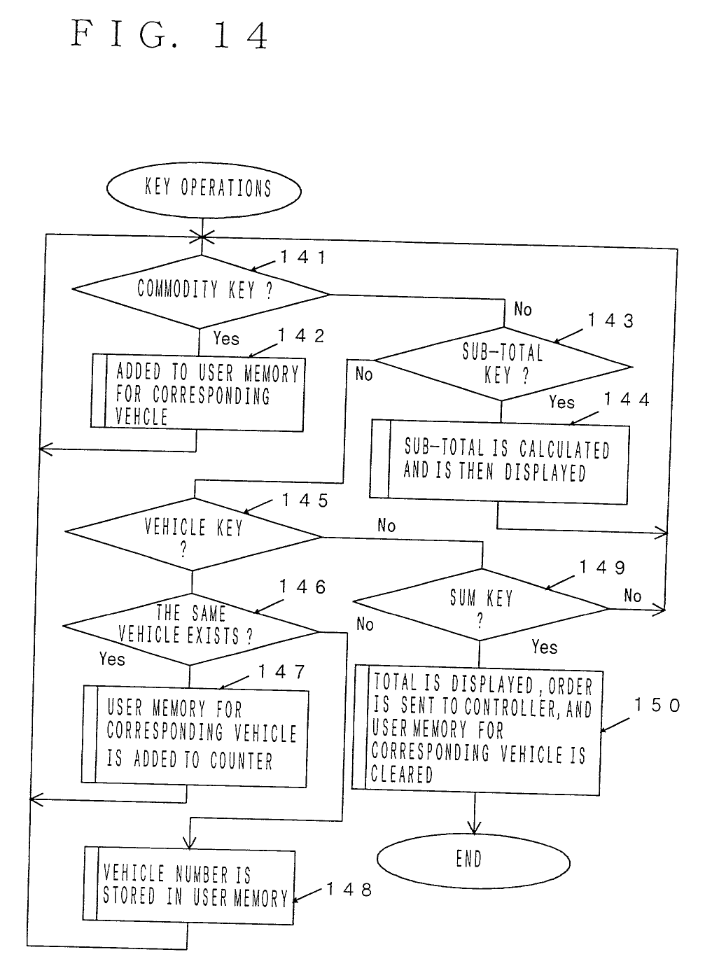

FIG. 12 illustrates an example of keyboard operations during order registration according to the second embodiment. For example, when an order from a customer having vehicle number 5086 is entered, vehicle number 5086 is entered via the numeral keys 102 at step 121 before the vehicle key 104 is pressed. At subsequent steps 122-125, commodity names and quantities are entered via the commodity keys 101 and the numeral keys 102, respectively. At step 126, the serve key 105 is pressed, thereby storing the vehicle number information 111 and the detailed order information 112 into the user memory 95. In this way, the order-taking register is able to register the orders in advance irrespective of the sequence of queuing automobiles. As illustrated in FIG. 13, when the order from the automobile arriving at the order booth is processed, vehicle number 5086 is entered via the numeral keys 102, and then the vehicle key 104 is pressed at step 131. Subsequently, the sum key 106 is pressed. As a result, order details for the corresponding vehicle number are read out from the user memory 95, which means that the automobile identifies with the order. The order details are then sent to the controller via the communication circuit 99.

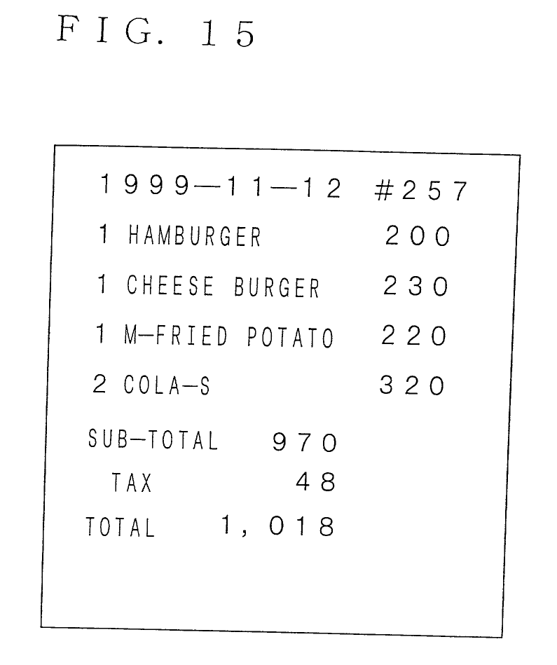

FIG. 14 a schematic routine for key processing at the CPU 91 during the above steps. At initial step 141, it is determined whether the commodity key 101 is pressed, and when the determination in step 71 results in a positive answer, then the routine is advance to step 142, or otherwise is moved to step 143. At step 142, registered commodities are added to the user memory 95 for the corresponding vehicle under order registration, and then the routine is returned to step 141. At step 143, it is determined whether the subtotal key 103 is pressed, and when determination in step 143 results in a positive answer, then the routine is advanced to step 144, or otherwise is moved to step 145. At step 144, a subtotal amount of money is calculated and then displayed on the indicator 93 before the routine is returned to step 141. The above description is concerned with an additional routine. When no commodity is added, processing starts with step 145. At step 145, it is determined whether the vehicle key 104 is pressed after entry of numerals (vehicle number), and when the determination in step 145 results in a positive answer, then the routine is advanced to step 146, or otherwise is shifted to step 149. At step 146, it is determined whether the same vehicle number exists, and when the determination in step 146 results in a positive answer, then the routine is advanced to step 147, or otherwise is shifted to step 148. At step 147, order details for the corresponding vehicle number are called from the user memory 95, and then a selling price and a quantity are added to the counter memory 97. At step 148, the vehicle number is saved in the user memory 95 because it is a new vehicle number. When no commodity is added, the routine is shifted to step 149. At step 149, it is determined that the sum key 106 is pressed, and when the determination in step 149 results in a positive answer, then the routine is advanced to step 150, or otherwise is returned to step 141. At step 150, a total amount of money is displayed, and then the order details are sent to the controller via the communication circuit 99. A corresponding vehicle area is cleared from the user memory 95, and then one transaction is completed.

As described above, according to the second embodiment, there are provided with the keyboard 92 for entering the contents of the order form having the commodity names, quantities, and customer number or vehicle number recorded thereon, the user memory 95 for storing the entered commodity names, quantities, and customer number or vehicle number, and the CPU 91 for entering the vehicle number via the keyboard 92 in order to read from the user memory 92 the commodity names and quantities identified by the vehicle number, thereby calculating a selling price according to the quantities. Consequently, registering the order is completed before the customer comes to the order booth, and then the corresponding order is called according to the vehicle number when the customer comes to the order booth, thereby making it possible to identify the order with the customer. As a result, the orders can be registered in random. In addition, the customers can smoothly be identified with orders in sequence according to the customer numbers without mechanical steps, even if the customers are changed in sequence.

Although the customer's vehicle number is used as the customer number in the second embodiment, a numbered tag may be handed to the customer for use as the customer number.

(Third Embodiment)

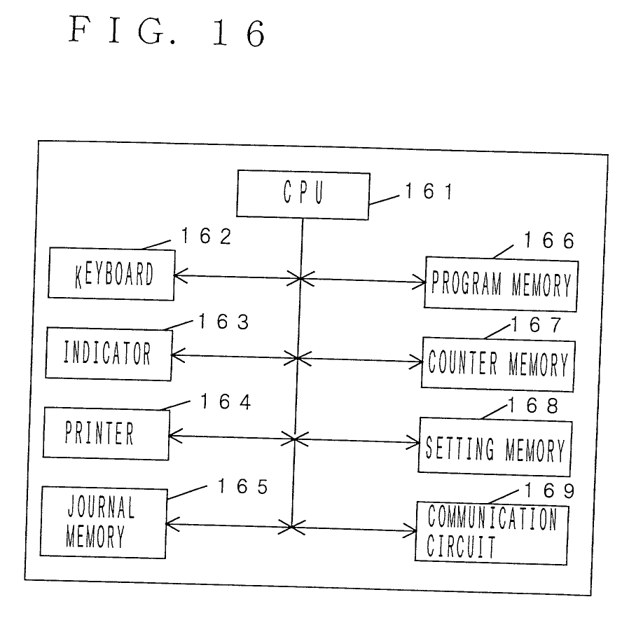

A commodity order-taking apparatus according to a third embodiment includes a journal memory that stores sale details. FIG. 15 illustrates an example of a printed receipt according to the third embodiment. An order-taking register registers an order taken in advance, while issuing the receipt. The receipt is then handed to a customer. When the customer comes to the order booth, then a receipt number on the receipt is entered into the order-taking register, thereby reading out the order from the order-taking register.

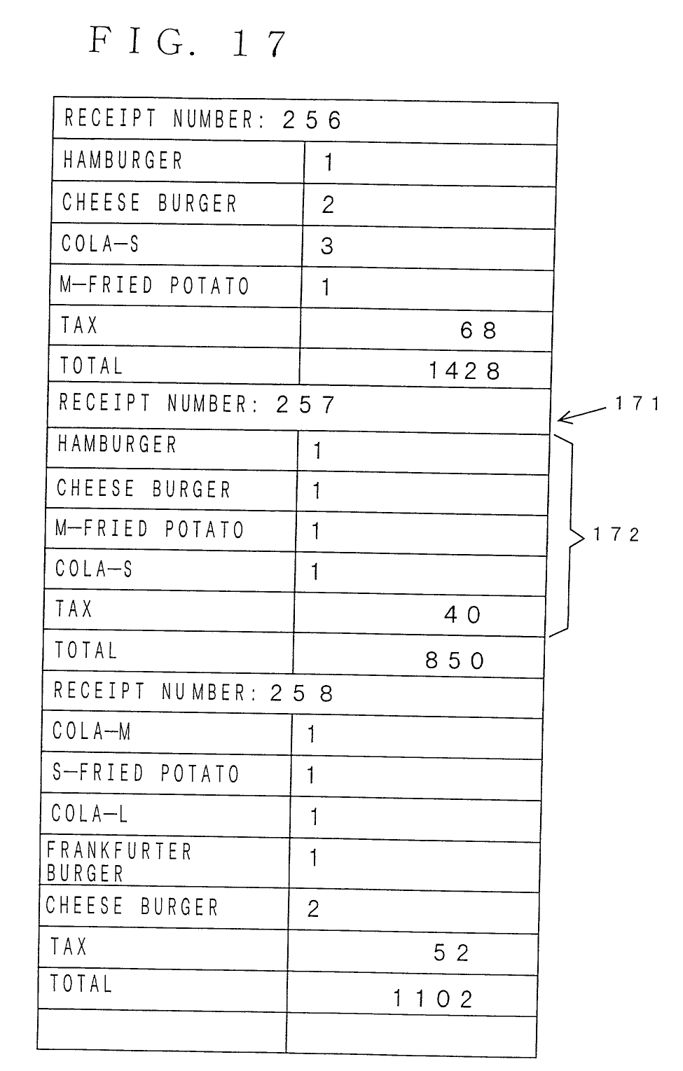

FIG. 16 illustrates an internal construction of the order-taking register according to the third embodiment. The order-taking register includes a CPU 161 for providing calculation and input-output control according to a program, a keyboard 162 for registering commodities and entering an amount of money, an indicator 163 for indicating registered contents, a printer 164 for printing the receipt, the journal memory 165 for storing the sale details, a program memory 166 containing an operating program, a counter memory 167 for storing a selling price and quantities of the commodities, a setting memory 168 for storing commodity names and unit prices thereof, and a communication line 169 for communicating with a controller and a casher register. The above order-taking register differs from the order-taking register as shown in FIG. 3 in that the journal memory 165 is added to the latter register, but the reader I/F circuit is deleted therefrom. The keyboard is similar in construction to the keyboard as in shown FIG. 5, except that the read key 55 is deleted from the latter keyboard.

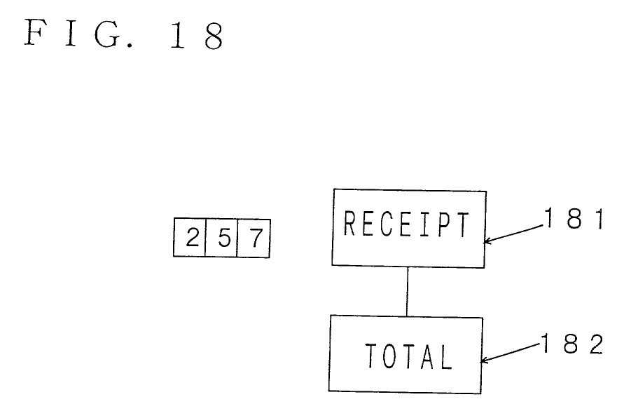

FIG. 17 illustrates what the journal memory 165 stores according to the third embodiment, which includes a piece of receipt number information 171 and another piece of information 172 that shows details of sold commodities, a tax, and a total amount of money.

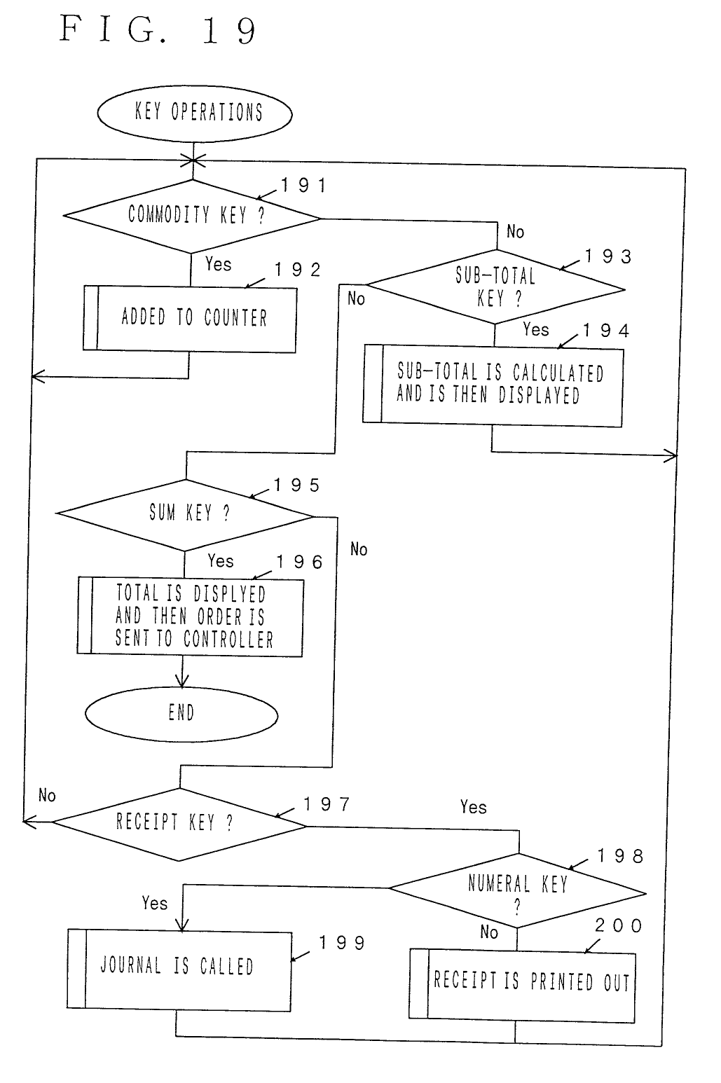

FIG. 18 illustrates an example of order-reading key operations when the customer comes to the order booth according to the third embodiment. At initial step 181, information about a receipt number is obtained out of the customer at the order booth, and then the receipt number 257 is entered via numeral keys before a receipt key is pressed. As a result, details of an order placed by the customer are read out from the journal memory 165, thereby identifying the customer with the order. At the following step 182, a sum key is pressed to send the receipt number and the order details to the controller via the communication circuit 169.

FIG. 19 a schematic routine for key processing at the CPU 161. At initial step 191, it is determined whether a commodity key 101 is pressed, and when the determination in step 101 results in a positive answer, then the routine is advanced to step 192, or otherwise is moved to step 193. At step 192, a unit price is read out from a table of a corresponding commodity, and then a selling price and a quantity are added to the counter memory 167 before the routine is returned to step 191.

At step 193, it is determined whether a subtotal key is pressed, and when determination in step 193 results in a positive answer, then the routine is advanced to step 194, or otherwise is moved to step 195. At step 194, a subtotal amount of money is calculated and then displayed on the indicator 163 before the routine is returned to step 191. At step 195, it is determined whether the sum key is pressed, and when the determination in step 195 results in a positive answer, then the routine is advanced to step 196 or otherwise is shifted to step 197. At step 196, a total amount of money is displayed on the indictor 163, and then the order is sent to the controller via the communication circuit 169, thereby completing one transaction. At step 197, it is determined that the receipt key is pressed, and when the determination in step 197 results in a positive answer, then the routine is advanced to step 198, or otherwise is returned to step 191. At step 198, it is determined whether the numeral keys are pressed or a receipt number is entered, and when the determination in step 198 results in a positive answer, then the routine is advanced to step 199, or otherwise is moved to step 200. At step 199, sale details identified by the entered receipt number are called from the journal memory 165. The called sale details are sent to the controller when the sum key is pressed at step 195. At step 200, the printer 164 issues a receipt having the receipt number placed thereon. This step is taken when the order is taken in advance at a position other than the order booth.

As described above, according to the third embodiment, there are provided with the keyboard 162 for entering the commodity names and the quantities thereof, the printer 164 for issuing the receipt containing the entered commodity names and quantities as well as the receipt number, the journal memory 165 for storing the entered commodity names and quantities as well as the receipt number, the CPU 161 for entering the receipt number via the keyboard 162 in order to read from the journal memory 165 the commodity names and quantities identified by the receipt number, thereby calculating a selling price on the basis of the quantities. Consequently, registering the order is completed before the customer comes to the order booth, and then the corresponding order is called according to the receipt number when the customer comes to the order booth, thereby making it possible to identify the order with the customer. As a result, the orders can be registered in random. In addition, the customers and the orders can smoothly be identified with one another in sequence according to the receipt numbers without mechanical steps, even if the customers are changed in sequence. Furthermore, the journal memory 165 can be substituted for a sheet of journal paper for use as an electronic storage means for a journal.

(Fourth Embodiment)

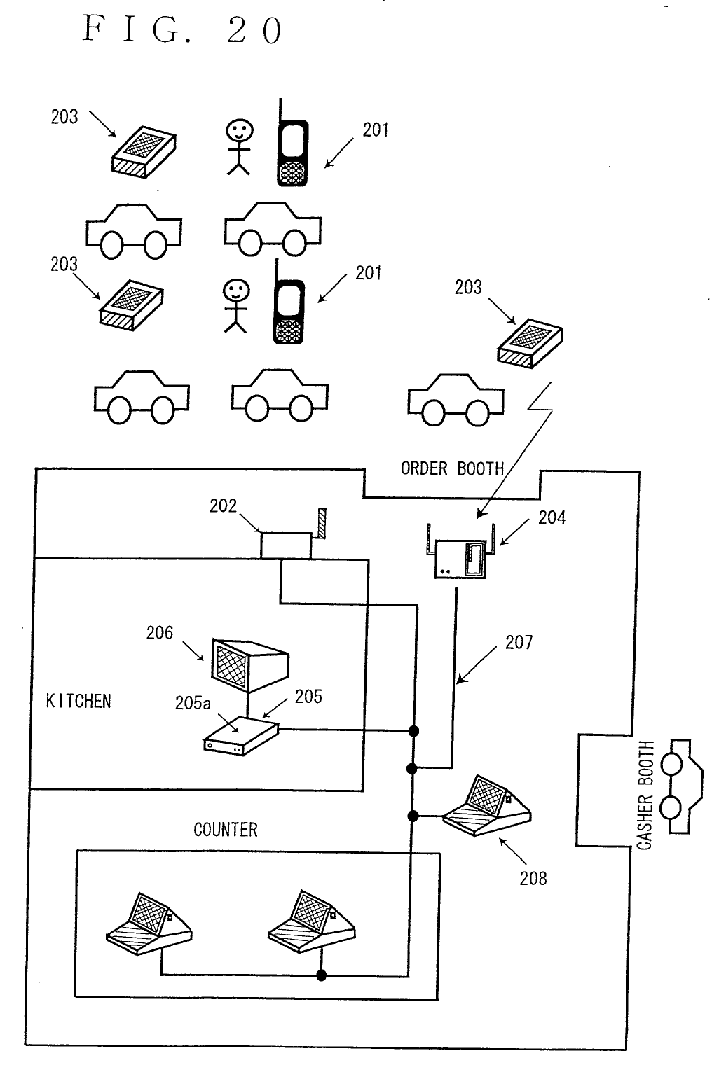

As illustrated in FIG. 20, a commodity order-taking apparatus according to a fourth embodiment includes a wireless order-taking portable terminal or wireless order taker (hereinafter called a wireless order-taking register) 201 for taking an order and then sending order contents therefrom to a receiver 202 disposed in an establishment. The order contents are further sent to a controller 205 via a communication cable 207. The controller 205 includes a display monitor 206 for displaying the order contents and an order memory 205a for temporarily storing data from the wireless order-taking register 201. A tag 203 for identifying each customer is handed to the customer during order taking. When the customer comes to an order booth, then the tag 203 and an interrogator 204 disposed at the order booth are automatically communicated with one another. The interrogator 204 reads an identification number on the tag, and then sends it to the controller 205 via the communication cable line 207. The controller 255 causes the order contents identified by the identification number to be displayed on the display monitor 256. Watching the display, an employee in a kitchen prepares commodities ordered, and then brings the prepared commodities to a casher booth. When a casher register 208 transmits a signal indicative of starting payment to the controller 205, then the order contents are called from the controller 205, and payment is made at the casher register 208.

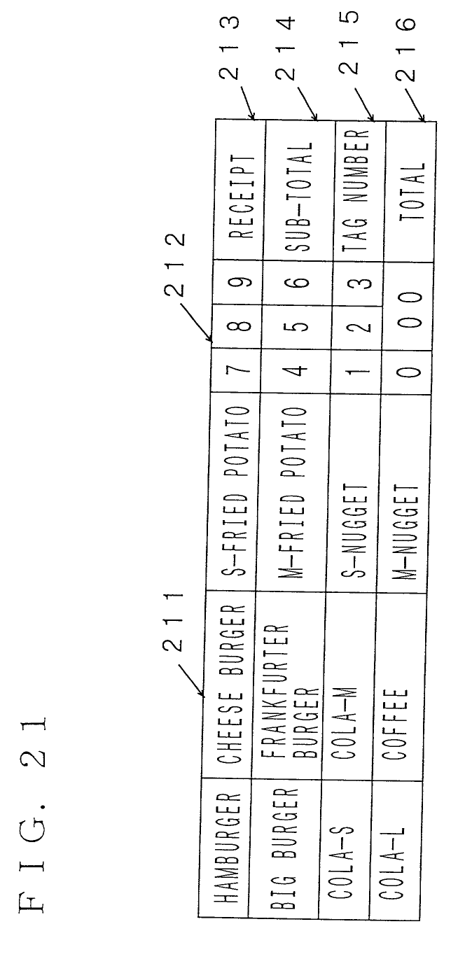

FIG. 21 illustrates a keyboard of the wireless order-taking register according to the fourth embodiment. The keyboard includes commodity keys 211 for entering kinds of commodities to be sold, numeral keys 212 for entering numerals, a receipt key 213 for issuing instructions to print a receipt, a subtotal key 214 for determining a subtotal amount of money, a tag key 215 for registering a tag number, and a sum key 216 for calculating a total amount of money and then sending an order to the controller.

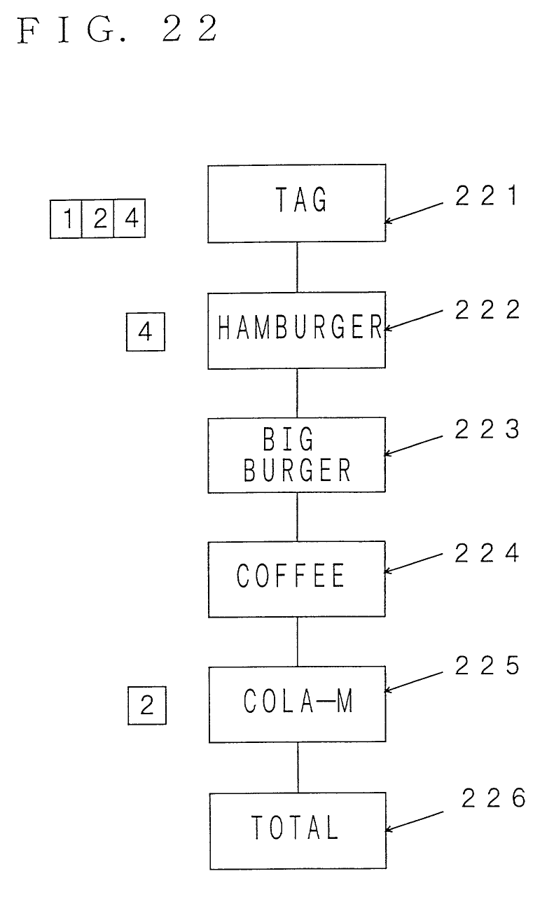

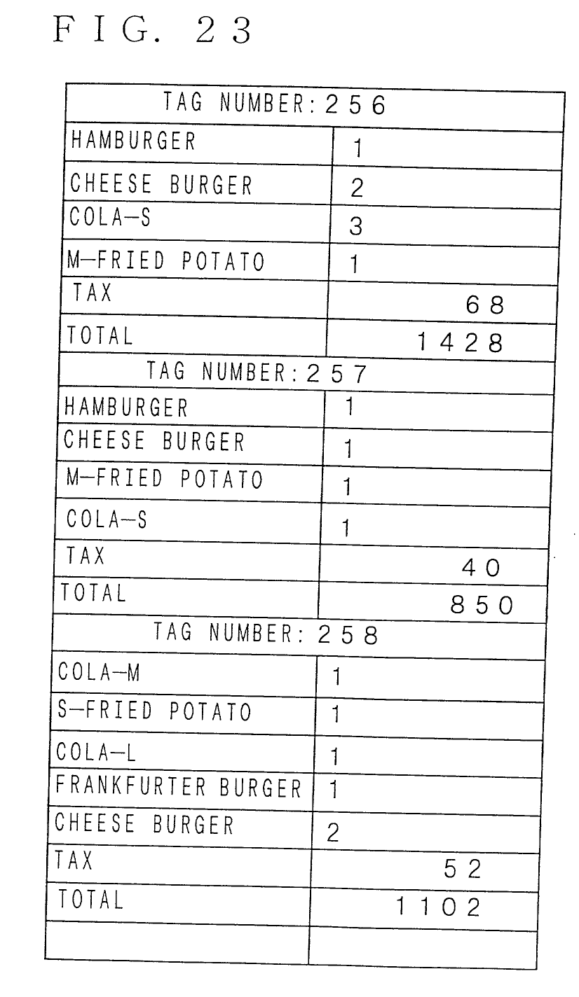

FIG. 22 illustrates an example of key operations for the wireless order-taking register 201 during order registration according to the fourth embodiment. At initial step 221, an employee hands the tag to each customer in an automobile when taking an order from the customer in advance. The tag shows a number. For example, assume that the tag handed to the customer contains tag number 124. When the order is registered, tag number 124 is entered from the wireless order-taking register 201 by means of the numeral keys 212 and the tag key 215. At subsequent steps 222 through 225, the commodity keys 211 and the numeral keys 212 are used to register the commodities. At step 226, the sum key is pressed to send the tag number and order details to the receiver 202 by wireless. The receiver 202 converts wireless data in such a manner as to be suited for the communication line laid in the establishment. The data sent from the wireless order-taking register 201 is transmitted to the controller 205, and is then primarily stored in the order memory 205a as illustrated in FIG. 23. In this way, the orders can be registered irrespective of the sequence of the automobiles.

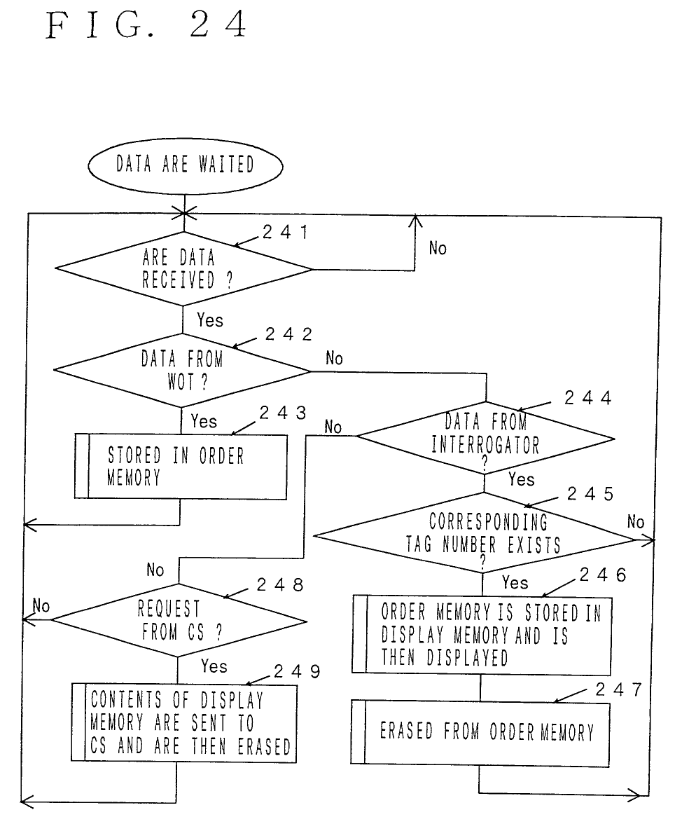

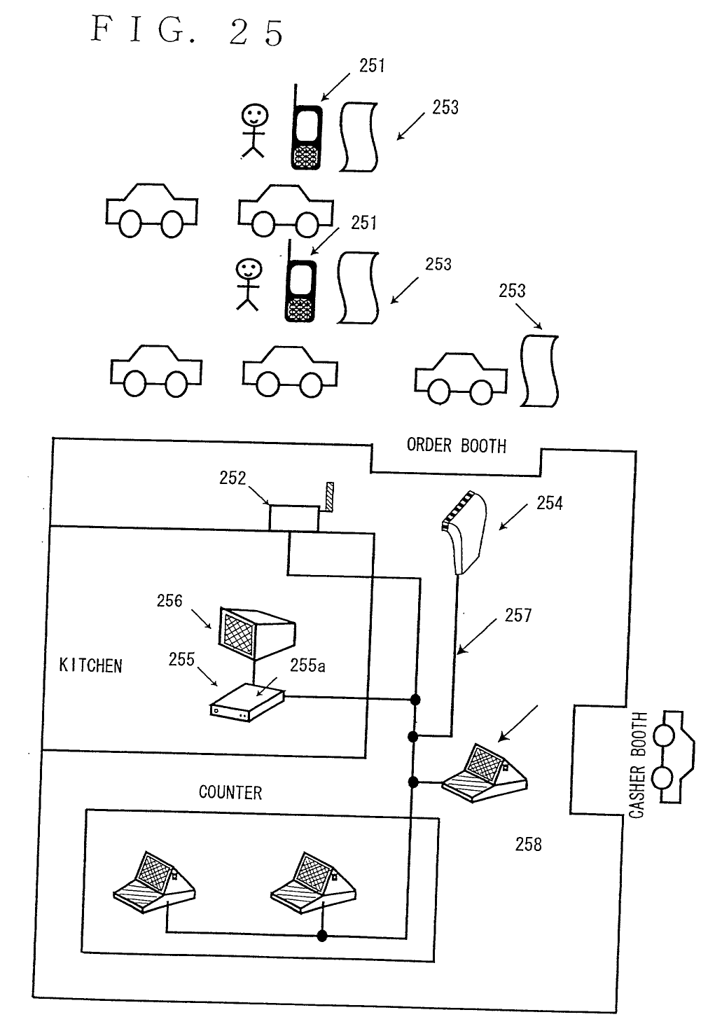

As illustrated in FIG. 20, the interrogator 204 constantly sends an interrogatory radio wave to each tag 203, but no responses are returned to the interrogator 204 from the tags 203 located at positions where orders are taken from the customers because the radio wave from the interrogator 204 does not reach the tags 203 at such positions. However, when the automobile comes to the order booth, then the interrogatory radio wave from the interrogator 204 reaches the tag 203, and a respondent radio wave is sent back from the tag 203 to the interrogator 204. The interrogator 204 then reads a tag number from the tag 203, and then sends the tag number to the controller 205 via the cable 207. The controller 205 retrieves the orders stored in the order memory 205a, and then displays the corresponding order contents on the display monitor 206. In this way, the customers can be identified with the orders. FIG. 24 illustrates a schematic routine for data processing in the controller 205 during the above steps. At initial step 241, it is determined whether the controller 205 receives the data, and when the determination in step 241 results in a positive answer, then the routine is advanced to step 242, or otherwise is returned to step 241. At step 242, it is determined whether the data is sent from the wireless order-taking register (WTO) 201, and when the determination in step 242 results in a positive answer, then the routine is advanced to step 243, or otherwise is moved to the step 244. At step 243, the data from the wireless order-taking register 201 is stored in the order memory 205a, and then the routine is returned to step 241. At step 244, it is determined whether the data is sent from the interrogator 204, and when the determination in step 244 results in a positive answer, then the routine is advanced to step 245, or otherwise is brought to step 248. At step 245, it is determined whether a corresponding tag number is present in the order memory 205a, and the determination in step 245 results in a positive answer, then the routine is advanced to step 246, or otherwise is returned to step 241. At step 246, the contents of the order memory 205a are stored in a display memory, and then the order contents are displayed on the display monitor 206 before the routine is advanced to step 247. At step 247, the displayed order is erased from the order memory 205a, and then the routine is returned to step 241. At step 248, it is determined whether the casher register (CS) 208 requests the data, and when the determination in step 248 results in a positive answer, then the routine is advanced to step 249, or otherwise is returned to step 241. At step 249, the controller 205 transmits the order from the automobile at the casher booth to the casher register 208 (in sequence of order receipt at the order booth) under demand from the casher register 208, and then erases the transmitted order contents from the order memory 205a before the routine is returned to step 241.

As described above, according to the four embodiment, there are provided with the tag 203 capable of transmitting the identification number, a portable terminal means or the wireless order-taking register 201 for entering and then transmitting commodity data by wireless, the commodity data including commodity names, quantities thereof, and a selling price as well as the identification number, the receiver 202 for receiving the commodity data from the wireless order-taking register 201, a responding means or the interrogator 204 for receiving the identification number from the tag 203, and a control means or the controller 205 for retrieving specific commodity data from among the commodity data received by the receiver 202, the specific commodity data being identified by the identification number entered from the interrogator 204. The controller 205 retrieves the order contents from the order memory 205a, which order contents are identified by the tag number sent from the interrogator 204, and then displays such order contents on the display monitor 206. As a result, the orders taken in random can be changed in sequence of customers who arrive at the order booth, and can be processed at an improved speed. In addition, no employee is required at the order booth, and the establishment can be operated at reduced costs.

(Fifth Embodiment)

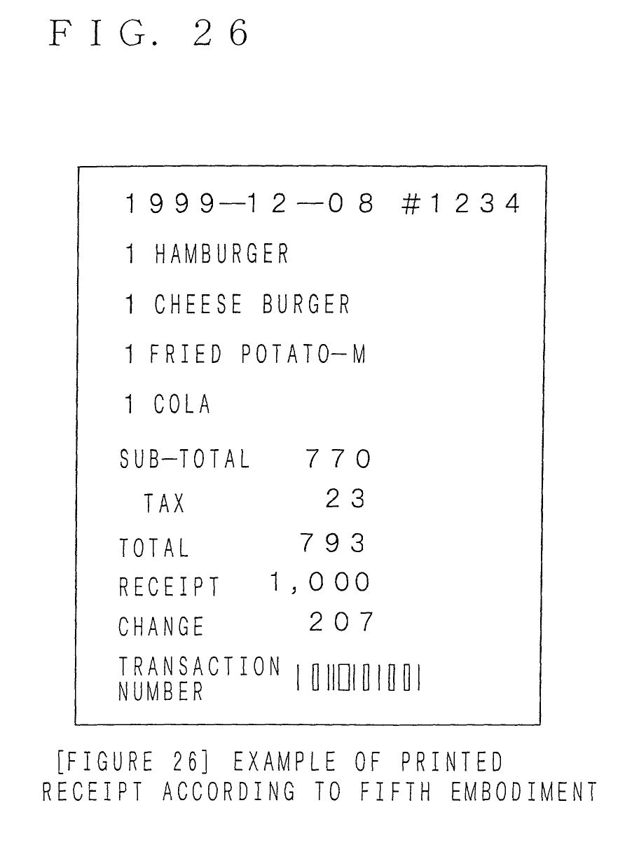

As illustrated in FIG. 25, a commodity order-taking apparatus according to a fifth embodiment employs a receipt having a receipt number printed thereon in a barcode instead of the tag according to the fourth embodiment. An order is taken by means of a wireless order-taking register 251 having the function of printing the receipt with the barcode, and then order contents are sent from the register 251 to a receiver 252 disposed in an establishment. The receiver 252 transmits the order contents to a controller 255 via a communication cable 257. The controller 255 is provided with a display monitor 256 for displaying the order contents and an order memory 255a for temporarily storing data from the wireless order-taking register 251. At the end of order taking, the wireless order-taking register 251 issues a barcode-containing receipt 253 as illustrated in FIG. 26. The receipt is handed to the customer. A barcode contains a receipt number. When the customer comes to an order booth, then an employee receives the receipt 253 from the customer, and then reads the barcode by means of a barcode reader 254, thereby sending the receipt number to the controller 255 via the cable 257. The controller 255 retrieves from the order memory 255a specific order contents identified by the receipt number, and then displays the order contents on the display monitor 256. Watching the display, another employee in a kitchen prepares commodities, and then carries the prepared commodities to a casher booth. When a signal indicative of starting payment is entered into the controller 255 from a casher register 258, then the order contents are called from the controller 255, and payment is made at the casher register 258.

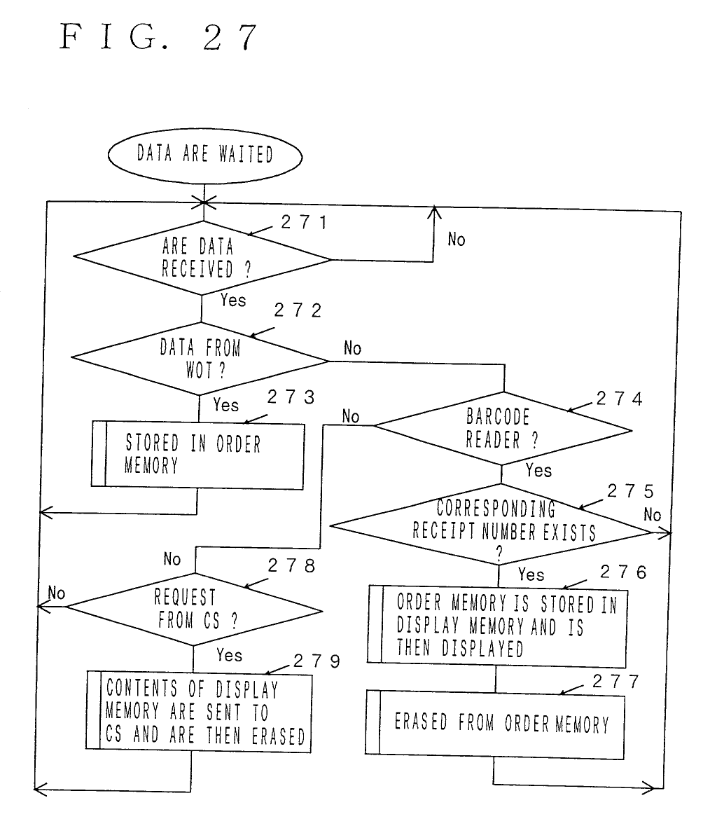

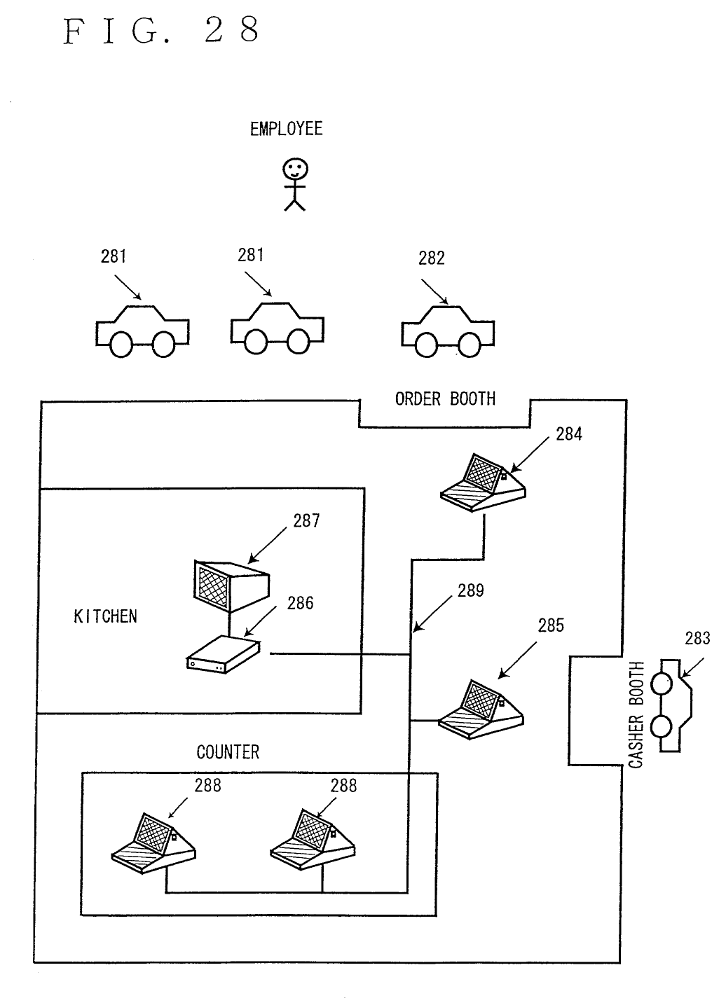

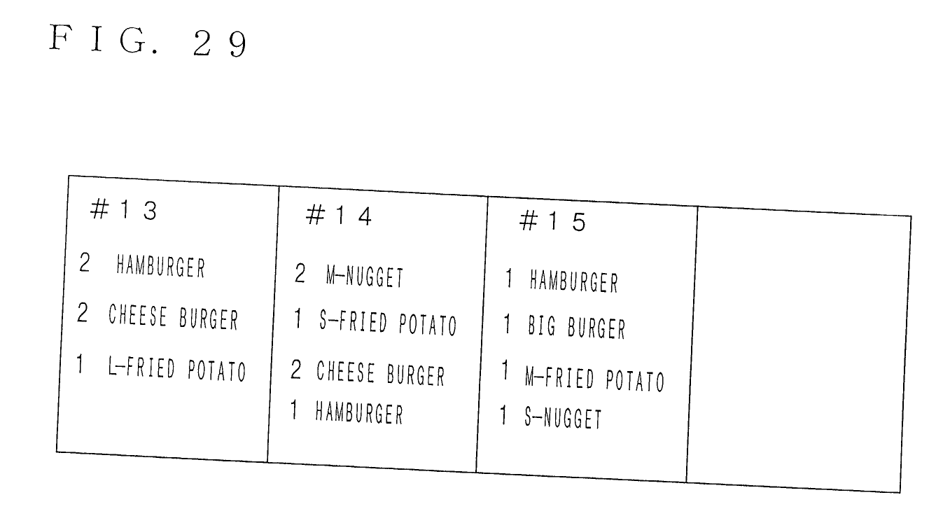

FIG. 27 illustrates a schematic routine for data processing in the controller 255 during the above steps. At initial step 271, it is determined whether the controller 255 receives data, and when the determination in step 271 results in a positive answer, then the routine is advanced to step 272, or otherwise is returned to step 271. At step 272, it is determined whether the data is sent from the wireless order-taking register (WTO) 251, and when the determination in step 272 results in a positive answer, then the routine is advanced to step 273, or otherwise is shifted to step 274. At step 273, the data from wireless order-taking register 251 is stored in the order memory 255a, and then the routine is returned to step 271. At step 274, it is determined whether the data is transmitted from the barcode reader 254, and when the determination in step 274 results in a positive answer, then the routine is advanced to step 275, or otherwise is shifted to step 278. At step 275, it is determined whether the order memory 255a contains a corresponding receipt number, and when the determination in step 275 results in a positive answer, then the routine is advanced to step 276, or otherwise is returned to step 271. At step 276, the contents of the order memory 255a are stored in a display memory, and then the order contents are displayed on the display monitor 256 before the routine is advanced to step 277. At step 277, the displayed order is erased from the order memory, and then the routine is returned to step 271. At step 278, it is determined whether the casher register (CS) 258 requests the data, and when the determination in step 278 results in a positive answer, then the routine is advanced to step 279, or otherwise is returned to step 271. At step 279, the controller 255 transmits to the casher register 258 the order from automobile at the casher booth (in sequence of order receipt at the order booth), and then the transmitted order is erased from the order memory 255a before the routine is returned to step 271.

As described above, according to the fifth embodiment, there are provided with the portable terminal means or the wireless order-taking register 251 for entering and then sending commodity data by wireless, the commodity data including commodity names, quantities thereof, and a selling price as well as the receipt number, the portable terminal means or the wireless order-taking register 251 further for issuing the receipt having the receipt number printed thereon in the barcode, the receiver 252 for receiving the commodity data from the wireless order-taking register 251, the barcode reader 254 for reading the receipt number in the barcode from the receipt, and the controller 255 for retrieving specific commodity data from among the commodity data received by the receiver 252, the specific commodity data being identified by the receipt number entered from the barcode reader 254. The controller 255 retrieves from the order memory 255a the order contents identified by the receipt number sent from barcode reader 254, and then displays such order contents on the display monitor 256. As a result, the orders taken at random can be changed in sequence of the customers who arrive at the order booth, and can be processed at an improved speed. In addition, the use of a system in which the customers scan the barcodes on their receipts by themselves eliminates the employee at the order booth, and the establishment can be run at reduced costs.

As evidenced by the above description, the present invention makes it feasible to automatically identify the customers with the orders in sequence when the customers come to the order booth, which orders are taken at random in advance. As a result, the present invention is operative in eliminating the crowd at the order window, reducing order-taking time, and highly satisfying the customers.

What is claimed is:

1. A commodity order-taking method comprising the steps of:
taking an order for a commodity from each customer in advance, recoding the order on a slip, and then handing the slip to the customer before the order is accepted at an order window;
passing the slip from the customer to the order window when the customer comes to the order window;
reading the slip using a reader at the order window; and
entering it into a register, thereby identifying the customer at the order window with order contents.

2. A commodity order-taking apparatus comprising:
a reading means for reading the contents of a slip having a commodity name and its quantity recorded thereon at specific locations; and
a commodity-registering means connected to the reading means for registering a commodity ordered, its quantity, and a selling price according to the read contents of the slip, the commodity-registering means including a set price-storing means for storing a position and unit price of each commodity name presented on the slip and a calculating means for checking position data read from the slip by the reading means against position data stored in the set price-storing means according to the slip, thereby determining the commodity and then calculating the selling price on the basis of the quantity of the determined commodity.

3. A commodity order-taking method comprising the steps of:
taking an order for a commodity from each customer in advance, recoding the order and a customer number on a slip, and registering the order and the customer number into a register before the order is accepted at an order window; and
entering the customer number into the register when the customer comes to the order window, thereby identifying the customer at the order window with order contents.

4. A commodity order-taking apparatus comprising:
an input means for entering the contents of a slip having a commodity name, its quantity, and a customer number recorded thereon;
a storage means for storing the entered commodity name, quantity, and customer number; and
a calculating means for entering the customer number via the input means in order to read from the storage means the commodity name and quantity identified by the customer number, thereby calculating a selling price on the basis of the quantity.

5. A commodity order-taking method comprising the steps of:
taking an order for a commodity from each customer in advance, registering the order into a register, and then handing to the customer a receipt containing a receipt number, before the order is accepted at an order window;
receiving the receipt from the customer when the customer comes to the order window; and
entering the receipt number into the register, thereby identifying the customer at the order window with order contents.

6. A commodity order-taking apparatus comprising:
an input means for entering a commodity name and its quantity;
a receipt-issuing means for issuing a receipt containing the entered commodity name and quantity as well as a receipt number;
a storage means for storing the entered commodity name and quantity as well as the receipt number; and
a calculating means for entering the receipt number via the input means in order to read from the storage means the commodity name and quantity identified by the receipt number, thereby calculating a selling price from the quantity.

7. A commodity order-taking method comprising the steps of:
taking an order for a commodity from each customer in advance, transmitting the order to a controller by wireless, and then handing to the customer a tag capable of sending out an identification number, before the order is accepted at an order window;
receiving the identification number from the tag when the customer comes to the order window; and
transmitting the identification number to the controller, thereby identifying the customer at the order window with order contents.

8. A commodity order-taking apparatus comprising:
a tag capable of transmitting an identification number;
a portable terminal means for entering and then transmitting commodity data by wireless, the commodity data including a commodity name, its quantity, and a selling price as well as the identification number;
a receiving means for receiving the commodity data from the portable terminal means;
a responding means for receiving the identification number from the tag; and
a control means for retrieving specific commodity data from among the commodity data received by the receiving means, the specific commodity data being identified by the identification number entered from the responding means.

9. A commodity order-taking method comprising the steps of:
taking an order for a commodity from each customer in advance, transmitting the order to a controller by wireless, and then handing the customer a receipt showing a receipt number, before the order is accepted at an order window;
reading the receipt number using a barcode reader when the customer comes to the order window; and
sending the receipt number to the controller, thereby identifying the customer at the order window with order contents.

10. A commodity order-taking apparatus comprising:
a portable terminal means for entering and then transmitting commodity data by wireless, the commodity data including a commodity name, its quantity, and a selling price as well as a receipt number, the portable terminal means further for issuing a receipt having the receipt number printed thereon in a barcode;
a receiving means for receiving the commodity data from the portable terminal means;
a reading means for reading the receipt number in the barcode from the receipt; and
a control means for retrieving specific commodity data from among the commodity data received by the receiving means, the specific commodity data being identified by the receipt number entered from the reading means.

11. A drive-through system employing a commodity order-taking method comprising the steps of:
taking an order for a commodity from each customer in advance, recoding the order on a slip, and then handing the slip to the customer before the order is accepted at an order window;
passing the slip from the customer to the order window when the customer comes to the order window;
reading the slip using a reader at the order window; and
entering it into a register, thereby identifying the customer at the order window with order contents.

12. A drive-through system provided with a commodity order-taking apparatus comprising:
a reading means for reading the contents of a slip having a commodity name and its quantity recorded thereon at specific locations; and
a commodity-registering means connected to the reading means for registering a commodity ordered, its quantity, and a selling price according to the read contents of the slip, the commodity-registering means including a set price-storing means for storing a position and unit price of each commodity name presented on the slip and a calculating means for checking position data read from the slip by the reading means against position data stored in the set price-storing means according to the slip, thereby determining the commodity and then calculating the selling price on the basis of the quantity of the determined commodity.

13. A drive-through system employing a commodity order-taking method comprising the steps of:
taking an order for a commodity from each customer in advance, recoding the order and a customer number on a slip, and registering the order and the customer number into a register before the order is accepted at an order window; and
entering the customer number into the register when the customer comes to the order window, thereby identifying the customer at the order window with order contents.

14. A drive-through system provided with a commodity order-taking apparatus comprising:
an input means for entering the contents of a slip having a commodity name, its quantity, and a customer number recorded thereon;
a storage means for storing the entered commodity name, quantity, and customer number; and
a calculating means for entering the customer number via the input means in order to read from the storage means the commodity name and quantity identified by the customer number, thereby calculating a selling price on the basis of the quantity.

15. A drive-through system employing a commodity order-taking method comprising the steps of:
taking an order for a commodity from each customer in advance and then registering the order into a register, and then handing to the customer a receipt containing a receipt number, before the order is accepted at an order window;
receiving the receipt from the customer when the customer comes to the order window; and
entering the receipt number into the register, thereby identifying the customer at the order window with order contents.

16. A drive-through system provided with a commodity order-taking apparatus comprising:
an input means for entering a commodity name and its quantity;
a receipt-issuing means for issuing a receipt containing the entered commodity name and quantity as well as a receipt number;
a storage means for storing the entered commodity name and quantity as well as the receipt number; and
a calculating means for entering the receipt number via the input means in order to read from the storage means the commodity name and quantity identified by the receipt number, thereby calculating a selling price from the quantity.

17. A drive-through system employing a commodity order-taking method comprising the steps of:
taking an order for a commodity from each customer in advance, transmitting the order to a controller by wireless, and then handing to the customer a tag capable of sending out an identification number, before the order is accepted at an order window;
receiving the identification number from the tag when the customer comes to the order window; and
transmitting the identification number to the controller, thereby identifying the customer at the order window with order contents.

18. A drive-through system provided with a commodity order-taking apparatus comprising:
a tag capable of transmitting an identification number;
a portable terminal means for entering and then transmitting commodity data by wireless, the commodity data including a commodity name, its quantity, and a selling price as well as the identification number;
a receiving means for receiving the commodity data from the portable terminal means;
a responding means for receiving the identification number from the tag; and
a control means for retrieving specific commodity data from among the commodity data received by the receiving means, the specific commodity data being identified by the identification number entered from the responding means.

19. A drive-through system employing a commodity order-taking method comprising the steps of:
taking an order for a commodity from each customer in advance, transmitting the order to a controller by wireless, and then handing the customer a receipt showing a receipt number, before the order is accepted at an order window;
reading the receipt number using a barcode reader when the customer comes to the order window; and
then sending the receipt number to the controller, thereby identifying the customer at the order window with order contents.

20. A drive-through system provided with a commodity order-taking apparatus comprising:
a portable terminal means for entering and then transmitting commodity data by wireless, the commodity data including a commodity name, its quantity, and a selling price as well as a receipt number, the portable terminal means further for issuing a receipt having the receipt number printed thereon in a barcode;
a receiving means for receiving the commodity data from the portable terminal means;
a reading means for reading the receipt number in the barcode from the receipt; and
a control means for retrieving specific commodity data from among the commodity data received by the receiving means, the specific commodity data being identified by the receipt number entered from the reading means.
